(19) United States
(12) Patent Application Publication
(10) Pub. No.: US 2009/0327605 A1
(43) Pub. Date: Dec. 31, 2009

(54) DISK ARRAY APPARATUS, CONTROLLER AND CONTROLLING METHOD THEREFOR, AND RECORDING MEDIUM IN WHICH CONTROLLING PROGRAM IS STORED

(75) Inventors: Hideo TAKAHASHI, Kawasaki (JP); Norihide Kubota, Kawasaki (JP); Yoshihito Konta, Kawasaki (JP); Atsushi Igashira, Kawasaki (JP); Mikio Ito, Kawasaki (JP); Hidejirou Daikokuya, Kawasaki (JP); Kazuhiko Ikeuchi, Kawasaki (JP); Chikashi Maeda, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/406,287

(22) Filed: Mar. 18, 2009

(30) Foreign Application Priority Data
Jun. 27, 2008 (JP) 2008-168720

(51) Int. Cl. G06F 12/00

(52) U.S. Cl. 711/114; 711/E12.001

(57) ABSTRACT

A disk array apparatus includes a first converting unit that performs first conversion on storing object data received in a first control unit from a controller to convert the storing object data into data in a second control unit, the controller including a selecting section that selects, on the basis of the access state monitored by a monitoring section, one from the controller and said first converting unit, and a second converting unit that performs, if the controller is selected by the selecting section, a second conversion, different from the first conversion, on the object data to convert the object data managed in the first control unit into the data in the second control unit. With this configuration, the disk array apparatus accomplishes the object to improve the accessibility to different types of storage units that manage data storing in different control units.

### CROSS-REFERENCE TO RELATED APPLICATIONS

This application is based upon and claims the benefit of priority of the prior Japanese Patent Application No. 2008-168720, filed on Jun. 27, 2008, the entire contents of which are incorporated herein by reference.

### FIELD

The embodiment discussed herein is a technique of file control performed in a disk array apparatus with a number of disks and is preferably applied to, for example, a disk array apparatus with different type disks.

### BACKGROUND

A conventional disk array apparatus exemplified by a RAID apparatus uses FC (Fibre Channel) disks, which generally manage the data storing in an LBA (Logical Block Addressing) unit of 520 bytes.

A conventional disk array apparatus may use, as a substitute for an FC disk, an SATA (Serial ATA) disk, which is cheaper in cost but is lower in accessibility (e.g., processing speed or reliability) in public knowledge.

Accordingly, such a conventional disk array apparatus uses FC disks for operations such as on-line operations requiring accessibility in a predetermined level and SATA disks for operations such as backing up not requiring high accessibility. Consequently, a conventional disk array apparatus may arrange an FC disk and an SATA disk on the same loop, which means here that these disks are accessibly coupled to the CM (Control Module) included in the disk array through an identical access path. [Patent Reference 1] Japanese Laid-Open Publication No. 2006-146633

[Patent Reference 2 Japanese Laid-Open Publication No. 2007-264917

However, a SATA disk generally controls data storing in an LBA unit length of 512 bytes differently from an FC disk. As described above, most conventional disk array apparatus basically manage disk access in a unit of 520 bytes.

Accordingly, such a conventional disk array apparatus which arranges an FC disk and an SATA disk on the same loop cannot store data processed in the CM in a unit of 520 bytes into the SATA disk without modification on the data. For this purpose, the data managed in a unit of 520 bytes by the CM are converted into data in a unit of 512 bytes before storing into an SATA disk. Methods of conversion of the LBA unit length of a data are disclosed in, for example, Patent References 1 and 2.

In most cases, an FC disk is used in operation, such as important on-line operation, that requires a predetermined level of accessibility. It is therefore preferable that a process directed to an FC disk is preferentially performed even if the FC disk is arranged on a loop also including an SATA disk.

However, above Patent References 1 and 2 do not disclose that a process directed to an access to an FC disk is preferentially performed.

### SUMMARY

According to an aspect of an embodiment, a disk array apparatus disclosed herein includes: a first storage unit storing data in a first control unit; a second storage unit storing data in a second control unit different from the first control unit; a controller managing data in the first control unit and controlling data storing into the first storage unit and the second storage unit; and a first converting unit, arranged on a first access path between the controller and the second storage unit, if receiving object data to be stored into the second storage unit which object data is in the first control unit, performing a first conversion on the object data to convert the object data into data in the second control unit, the controller including a monitoring section monitoring a state of access to the first storage unit, a selecting section selecting, on the basis of the state monitored by the monitoring section, one from the controller and the first converting unit when the object data managed in the first control unit is to be stored into the second storage unit, and a second converting unit performing, if the controller is selected by the selecting section, a second conversion, different from the first conversion, on the object data to convert the object data managed in the first control unit into data in the second control unit.

As another aspect of the invention, there is provided a controller for a disk array apparatus including a first storage unit storing data in a first control unit, a second storage unit storing data in a second control unit different from the first control unit, a first converting unit, arranged on a first access path between the controller and the second storage unit, if receiving object data to be stored into the second storage unit which object data is in the first control unit, performing a first conversion on the object data to convert the object data into data in the second control unit, the controller that manages data in the first control unit and controls data storing into the first storage unit and the second storage unit including: a monitoring section monitoring a state of access to the first storage unit; a selecting section selecting, on the basis of the state monitored by the monitoring section, one from the controller and the first converting unit when the object data managed in the first control unit is to be stored into the second storage unit; and a second converting unit performing, if the controller is selected by the selecting section, a second conversion, different from the first conversion, on the object data to convert the object data managed in the first control unit into data in the second control unit.

Further, as additional aspect of the embodiment, a method for controlling a disk array apparatus including a first storage unit storing data in a first control unit, a second storage unit storing data in a second control unit different from the first control unit, a controller managing data in the first control unit and controlling data storing into the first storage unit and the second storage unit, and a first converting unit, arranged on a first access path between the controller and the second storage unit, if receiving object data to be stored into the second storage unit which object data is in the first control unit, performing a first conversion on the object data to convert the object data into data in the second control unit, the method includes: monitoring of a state of access to the first storage unit; when the object data managed in the first control unit is to be stored into the second storage unit, selecting, on the basis of the state monitored in the step of monitoring, one from the controller and the first converting unit and performing, if the controller is selected in the step of selecting, a second conversion, different from the first conversion, on the object data to convert the object data managed in the first control unit into data in the second control unit.

As a further aspect of the embodiment, there is provided a computer readable recording medium in which a program for a controlling a disk array apparatus including a first storage unit storing data in a first control unit, a second storage unit storing data in a second control unit different from the first control unit, a controller managing data in the first control unit and controlling data storing into the first storage unit and the second storage unit, and a first converting unit, arranged on a first access path between the controller and the second storage unit, if receiving object data to be stored into the second storage unit which object data is in the first control unit, performing a first conversion on the object data to convert the object data into data in the second control unit, wherein the program instructs a computer to function as: a monitoring section monitoring a state of access to the first storage unit, a selecting section selecting, on the basis of the state monitored by the monitoring section, one from the controller and the first converting unit when the object data managed in the first control unit is to be stored into the second storage unit, and a second converting unit performing, if the controller is selected by the selecting section, a second conversion, different from the first conversion, on the object data to convert the object data managed in the first control unit into data in the second control unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram schematically depicting an example of the configuration of a RAID apparatus according to a first embodiment;

FIG. 2 is a table depicting properties of an FC disk and an SATA disk included in a RAID apparatus of the first embodiment;

FIG. 3(a) is a diagram depicting an example of configuration of FC logic data formed in a first LBA unit length in a RAID apparatus of the first embodiment;

FIG. 3(b) is a diagram depicting an example of configuration of SATA physical data formed in a second LBA unit length in a RAID apparatus of the first embodiment;

FIG. 4 is a diagram depicting a function of a bridge in a RAID apparatus of the first embodiment;

FIG. 5 is a table schematically depicting an example of disk configuration information stored in a management information retaining section in a RAID apparatus of the first embodiment;

FIG. 6 is a diagram depicting an example of a management table stored in a management information retaining section in a RAID apparatus of the first embodiment;

FIG. 7 is a diagram explaining a function of a CM firmware of a RAID apparatus of the first embodiment; and

FIG. 8 is a flow diagram depicting a succession of procedural steps performed for a method of file controlling in a RAID apparatus of the first embodiment.

### DESCRIPTION OF EMBODIMENT

Hereinafter, a description will now be made in relation to a first embodiment of the present invention with reference to accompanying drawings.

### (a) First Embodiment

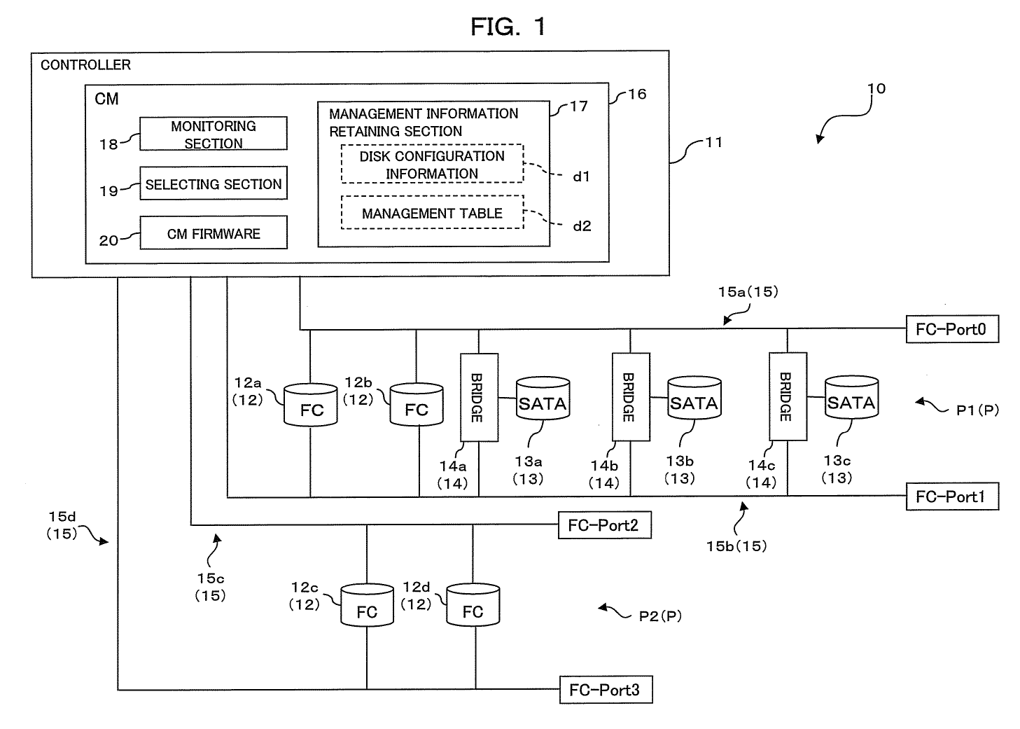

FIG. 1 is a block diagram schematically illustrating a RAID apparatus 10 according to a first embodiment.

The RAID apparatus (disk array apparatus) 10 of the first embodiment includes, as depicted in FIG. 1, a controller 11, a number (four in the example of FIG. 1) of FC (Fibre Channel) disks (first storage units) 12a-12d, a number (three in the example of FIG. 1) of SATA disk (Serial ATA) disks (second storage units) 13a-13c, and a number (three in the example of FIG. 1) of bridges (convertors, first converting unit) 14a-14c.

In the first embodiment, the two FC disks 12a and 12b form a 0th RAID group; and the two FC disks 12c and 12d form a first RAID group. Further, the three SATA disks 13a-13c form a second RAID group. However, these groups do not appear in the drawings.

The 0th and the first RAID group are on the “RAID1” level, and the second RAID group is on the “RAID5” level. The RAID levels have been known to the public, so detailed description will be omitted here.

Hereinafter, the FC disks are discriminated from one another by reference numbers 12a-12d, but an arbitrary FC disk is represented by reference number 12.

Similarly, the SATA disks are discriminated from one another by reference numbers 13a-13c, but an arbitrary SATA disk is represented by reference number 13.

The FC disks 12 and the SATA disks 13 are connected to two FC paths (access paths) 15 accessible to the controller 11. Each of the FC paths 15 has one end connected to the controller 11 and the other end connected to an FC port. Each FC path 15 terminates at the other end connected to an FC port.

Specifically, two FC disks 12a and 12b and three SATA disks 13a, 13b and 13c are connected to two FC paths 15a and 15b, as depicted in FIG. 1. Each of FC paths 15a and 15b has one end connected to the controller 11. The other end of the FC path 15a is connected to an FC port 0 (see “FC-Port0” in FIG. 1), and other end of the FC path 15b is connected to an FC port 1 (see “FC-Port1” in FIG. 1).

In the same manner, two FC disks 12c and 12d are connected to two FC paths 15c and 15d. One end of each of the FC paths 15c and 15d are connected to the controller 11. The other end of the FC path 15c is connected to an FC port 2 (see “FC-Port2” in FIG. 1), and other end of the FC path 15d is connected to an FC port 3 (see “FC-Port3” in FIG. 1).

As a consequence, the two FC paths 15 are accessibly coupled to the FC disks 12 and the SATA disks 13, so that an FC loop P is formed.

In the example depicted in FIG. 1, the two FC paths 15a and 15b are accessibly coupled to the two FC disks 12a and 12b and the three SATA disks 13a, 13b, and 13c, so that the FC loop P1 is formed. In other words, the two FC disks 12a and 12b and the three SATA disks 13a, 13b, and 13c are connected in parallel on the same FC loop P1. With this configuration, both FC disks 12 and SATA disks 13 are arranged on the FC loop P1.

Similarly, the two FC paths 15c and 15d are accessibly coupled to the two FC disks 12c and 12d, so that an FC loop P2 is formed. In other words, the two FC disks 12c and 12d are connected in parallel on the same FC loop P2.

Hereinafter, the FC paths are discriminated from one another by the reference numbers 15a-15d, but an arbitrary FC path is represented by the reference number 15.

Similarly, the FC loops are discriminated from one another by the reference numbers P1 and P2, but an arbitrary FC loop is represented by the reference number P.

The SATA disks 13 are accessibly coupled to the controller 11 via bridges 14.

In the example of FIG. 1, the SATA disk 13a is accessibly coupled to a bridge 14a, which is accessibly coupled to the controller 11 via the two FC paths 15a and 15b; the SATA disk 13b is accessibly coupled to a bridge 14b, which is accessibly coupled to the controller 11 via the two FC paths 15a and 15b; further the SATA disk 13c is accessibly coupled to a bridge 14c, which is accessibly coupled to the controller 11 via the two FC paths 15a and 15b.

Hereinafter, the bridges are discriminated from one another by the reference numbers 14a-14c, but an arbitrary bridge is represented by the reference number 14.

A bridge 14 is arranged at a position on an access path between the controller 11 and an SATA disk 13 which position is branched from an access path between controller 11 and an FC disk 12.

Specifically, each of the bridges 14a-14c is arranged on a branch from the FC paths 15a and 15b, which also shared by the FC disks 12a and 12b, as depicted in FIG. 1. In other words, a position branched from access paths between the controller 11 and the FC disks 12 means an access path that connects the FC paths 15a and 15b so as to make an access to each of the SATA disks 13a-13c.

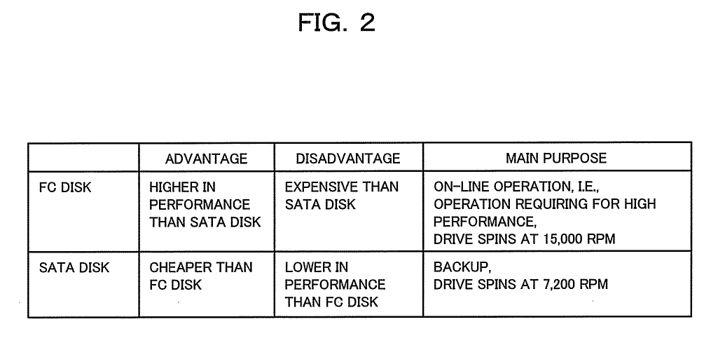

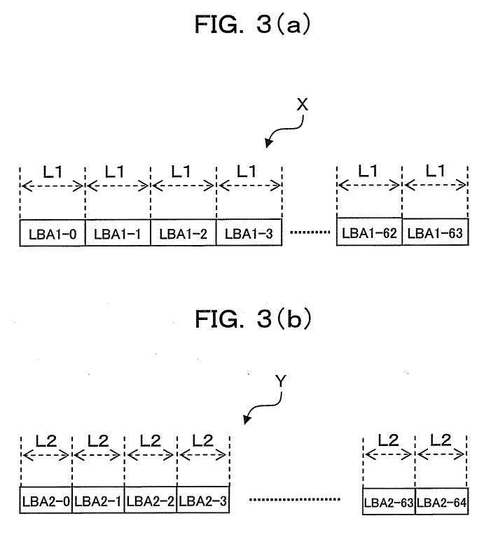

FIG. 2 is a diagram explaining the characteristics of the FC disk 12 and the SATA disk 13 of the RAID apparatus 10 of the first embodiment. FIG. 3(a) is a diagram depicting an example of the configuration of FC logical data X formed in a first LBA unit length L1; and FIG. 3(b) is a diagram depicting an example of the configuration of FC logical data Y formed in a second LBA unit length L2.

An FC disk 12 is higher in performance than an SATA disk 13 that is detailed below, but is more expensive than the SATA disk 13 (see FIG. 2). Accordingly, the FC disk 12 is used for operations requiring relatively high access capability (e.g., processing speed or reliability), such as on-line operations.

The FC disk 12 stores data in a first LBA (Logical Block Addressing) unit length (in a physical LBA length, a first control unit) L1, as depicted in FIG. 3.

Specifically, data (hereinafter also called FC logical data, see reference number “X” in FIG. 3(a)) stored in an FC disk 12 is formed from a number (64 in the example of FIG. 3(a)) of a first-unit data blocks LBA1-0 through LBA1-63. Each of data pieces LBA1-0 through LBA1-63 is configured in the first LBA unit length L1, which is 520 bytes in the first embodiment.

Hereinafter, the first-unit data blocks are discriminated from one another by reference numbers LBA1-0 through LBA1-63, but an arbitrary first-unit data block is represented by reference number LBA1.

An SATA disk 13 is cheaper than an FC disk 12, but is lower in performance than a FC disk 12 (see FIG. 2). Therefore, an SATA disk 13 is used for operation requiring only for relatively low accessibility, such as backup.

The SATA disk 13 stores data in a second LBA unit length (a second control unit) L2 different from the first LBA unit length L1 as depicted in FIG. 3(b).

Specifically, data (hereinafter also called SATA physical data, see reference number “Y” in FIG. 3(b)) stored in an SATA disk 13 is formed from a number (65 in the example of FIG. 3(b)) of second-unit data blocks LBA2-0 through LBA2-64. Each of the second-unit data blocks LBA2-0 through LBA2-64 is configured in the second LBA unit length L2, which is 512 bytes in the first embodiment.

Hereinafter, the second-unit data blocks are discriminated from one another by reference numbers LBA2-0 through LBA2-64, but an arbitrary second-unit data block is represented by reference number LBA2.

If a bridge 14 receives from the controller 11 data (hereinafter sometimes called storing object data) that is to be stored into the SATA disk 13 which data is in the first LBA unit length L1, the bridge 14 performs a first conversion (Reading, Modifying and Writing) on the received storing object data in order to convert the received storing object data to data in the second LBA unit length L2. Namely, when storing object data configured in the first LBA unit length L1 is to be stored into the SATA disk 13 in the second LBA unit length L2, the bridge 14 carries out the first conversion to modify the control unit of the storing object data. After that, the bridge 14 writes (stores) into the SATA disk 13 the storing object data which has been converted into data in the second LBA unit length L2 through the first conversion.

Here, the first conversion is executed by reading from the SATA disk 13 only data which is in a region to store storing object data in the first LBA unit length L1 and which is stored in the second LBA unit length L2 and merging the storing object data and the data read from the SATA disk 13.

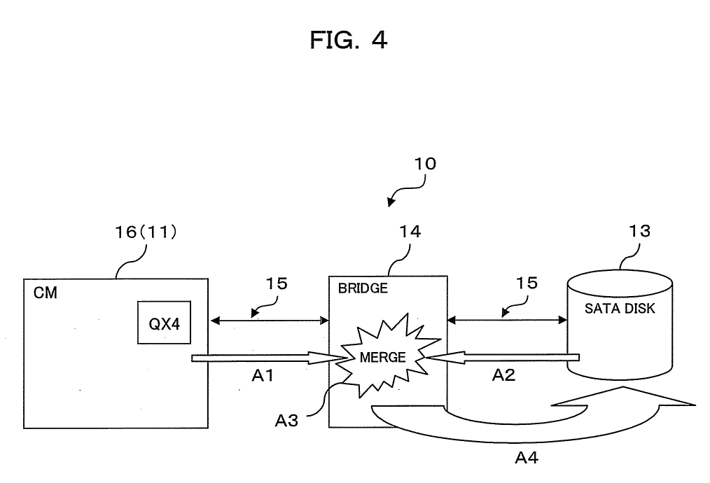

FIG. 4 is a diagram schematically showing a function of the bridge 14 included in the RAID apparatus 10 of the first embodiment.

Hereinafter, description will be made in relation to an example of the first conversion performed by the bridge 14 with reference to FIGS. 3(a), 3(b), and 4.

As depicted in FIG. 4, when a first-unit data block LBA1-1 of the FC logical data X depicted in FIG. 3(a) is to be updated, the bridge 14 receives from the controller 11 the first-unit data block LBA1-1 to serve as storing object data (see arrow A1 in FIG. 4). Upon receipt of the first-unit data blocks LBA1-1 from the controller 11, the bridge 14 reads a number of (two in the example of FIG. 3(b)) second-unit data blocks LBA2-1 and LBA2-2, into which the first-unit data block LBA1-1 is to be stored, among the SATA physical data Y (see FIG. 3(b)) stored in the SATA disk 13 associated with the bridge 14 in question (see arrow A2 in FIG. 4). In addition, the bridge 14 carries out the first conversion on the received first-unit data block LBA1-1, and then prompts the internal buffer of the same bridge 14 to merge the data that has been obtained through the first conversion on the first-unit data block LBA1-1 and the second-unit data blocks LBA2-1 and LBA2-2 that have been read (see arrow A2 in FIG. 4). Upon completion of merging, the bridge 14 writes the data which have obtained by merging and in which the first-unit data block LBA1-1 has been reflected into the region in which the second-unit data blocks LBA2-1 and LBA2-2 were stored in the associated SATA disk 13 (see arrow A4 in FIG. 4).

Here, the bridge 14 carries out the first conversion described above after carrying out serialization on the received storing object data because the bridge 14 is subjected to hardware constraints of incapability of multiple processes. Therefore, even if, for example, the controller 11 concurrently issues a number of writing requests (Write I/O), the bridge 14 seriarizes data associated with the issued writing requests and then performs conversion to deal with one of the issued writing requests at a time.

The bridge 14 performs the first conversion only when data received from the controller 11 is a wiring request (Write) in which an LBA to start writing into the SATA disk 13 is not a multiple of the number 64 or the data is a writing request in which the number of LBAs (FC logical LBAs) to be written into the SATA disk 13 is not a multiple of the number 64. This is because the second LBA unit length L2 that can be stored into the SATA disk 13 is 512 bytes while the first LBA unit length L1 that can be stored into the FC disk 12 is 520 bytes.

Here, an LBA to start writing into a disk represents an address number to specify a data block from which writing is to be started among n data blocks LBA 0 through n-1 that form a region into which storing object data is to be written where n is a natural number. For example, in the above data blocks LBA 0 through n-1, an LBA to start writing into a disk is the number among the address numbers 0 through n-1. In other words, the LBA to start writing into the SATA disk 13 not being a multiple of the number 64 means that the value to specify a data block from which data is written into the SATA disk 13 is not a multiple of the number 64.

The number of LBAs to be written into a disk represents the number of data blocks of storing object data that is to be written into a region serving as data storage of the disk. Namely, the number of LBAs which data is to be written into the SATA disk 13 being not a multiple of the number 64 means that the number of data blocks to be written into the SATA disk is not a multiple of the number 64.

Accordingly, upon receipt of storing object data formed in the second LBA unit length L2 serving as data to be used for updating from the controller 11, the bridge 14 passes the received storing object data kept in the second LBA unit length L2 therethrough. In other words, if the bridge 14 receives from the controller 11 storing object data formed in an LBA unit length of 512 bytes, the bridge 14 does not carry out the first conversion and writes into the SATA disk 13 the received storing object data without modification.

The controller 11 controls access to the FC disk 12 or SATA disk 13 in response to issue of a writing request from a higher apparatus (such as a Host, not depicted), and includes a CM (control module) as depicted in FIG. 1.

A CM 16 manages data in the first LBA unit length L1 and controls data storing (data writing) into the FC disks 12 and SATA disks 13. The CM 16 includes a management information retaining section 17, a monitoring section 18, a selecting section 19, and a CM firmware (a second converting section) 20.

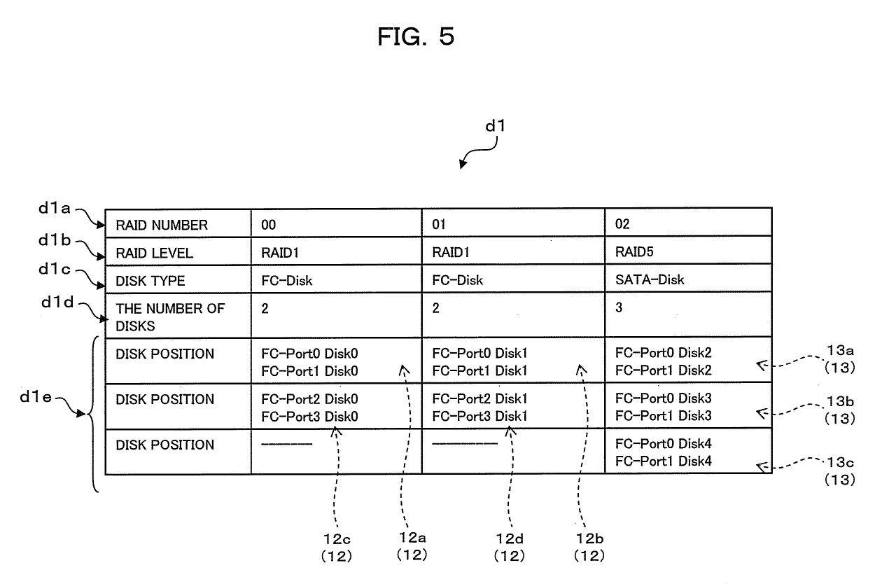

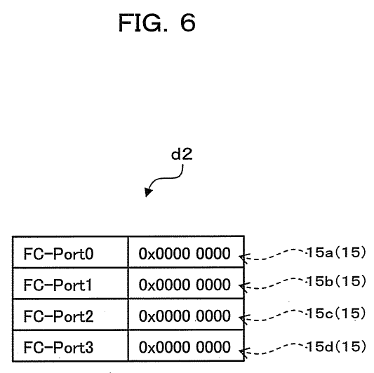

FIG. 5 is a diagram schematically depicting an example of disk configuration information d1 retained in the management information retaining section 17 of the RAID apparatus 10 of the first embodiment; and FIG. 6 is a diagram schematically depicting an example of a management table d2 stored in the management information retaining section 17.

The management information retaining section 17 stores data about the FC disks 12 and the SATA disks 13, and is realized by, for example, a storage such as a memory. The management information retaining section 17 includes, for example, the disk configuration information d1 and the management table d2.

The disk configuration information d1 manages RAID number d1a, RAID level d1b, disk type d1c, the number d1d of disks, and disk positions d1e for each RAID group, as depicted in the example of FIG. 5.

The RAID number d1a represents a serial number to specify one of a number of RAID groups. In the example of FIG. 5, RAID number d1a allocates “00” to the serial number for the 0th RAID group; “01” to the serial number of the first RAID group; and “02” to the serial number of the second RAID group. The RAID number d1a is not limited to the above example of the first embodiment and can alternatively be another discriminable information.

The RAID level d1b represents a RAID level of each RAID group. For example, the RAID level d1b selectively indicates one from RAID levels “RAID0”, “RAID1”, “RAID1+0”, “RAID2”, “RAID3”, “RAID4”, “RAID5”, and “RAID6”.

The RAID level d1b indicates RAID levels associated one with each of the RAID groups specified by RAID numbers d1a.

In the example of FIG. 5, the RAID level d1b associated with the 0th RAID group (RAID number “00”) is “RAID1”. Similarly, the RAID level d1b associated with the first RAID group (RAID number “01”) is “RAID1” and the RAID level associated with the second RAID group (RAID number “02”) is “RAID5”.

The disk type d1c represents a disk type used by each RAID group. In the first embodiment, the disk type d1c selectively indicates either “FC-Disk” or “SATA-Disk”. Here, disk type “FC-Disk” represents the FC disk 12 and disk type “SATA-Disk” represents the SATA disk 13.

The disk type d1c indicates disk types associated one with each of the RAID groups specified by RAID numbers d1a.

In the example of FIG. 5, the disk type d1c associated with the 0th RAID group (RAID number “00”) is “FC-Disk”. Similarly, the disk type d1c associated with the first RAID group (RAID number “01”) is “FC-Disk”; and the disk type d1c associated with the second RAID group (RAID number “02”) is “SATA-Disk”.

The number d1d of disks indicates the number of disks used for each RAID group. “Disks” represents here the FC disks 12 and the SATA disks 13 that form each RAID group.

The number d1d of disks indicates the number of disks associated with each of the RAID groups specified by RAID numbers d1a.

In the example of FIG. 5, the number d1d of disks associated with the 0th RAID group (RAID number “00”) is “2”. Similarly, the number d1d of disks associated with the first RAID group (RAID number “01”) is “2”; and the number d1d of disks associated with the second RAID group (RAID number “02”) is “3”.

The disk position d1e represents information (disk position specification information) to specify the position of a disk used in each of the RAID groups.

In the first embodiment, the disk position d1e is two FC ports connected to the other terminals of two FC paths 15 connected to the disk in question to serve as recognition information (hereinafter called FC path discrimination information) to specify the two FC paths connected. Further, the disk position d1e indicates recognition information (hereinafter disk recognition information to specify the disk in question that is arranged on the two FC paths 15. Therefore, the disk position d1e specifies the position of the disk in question with a combination of FC path recognition information and disk recognition information.

In the example of FIG. 5, the disk position d1e to specify the disk position of the FC disk 12a belongs to the 0th RAID group (RAID number “00”) is the combination of FC recognition information “FC-Port0” and disk discrimination information “Disk0” and a combination of FC recognition information “FC-Port1” and disk discrimination information “Disk0”. Further, the disk position d1e to specify the disk position of the FC disk 12b belongs to the 0th RAID group is the combination of FC recognition information “FC-Port2” and disk discrimination information “Disk0” and a combination of FC recognition information “FC-Port3” and disk discrimination information “Disk0”.

Similarly, the disk position d1e to specify the disk position of the FC disk 12b belongs to the first RAID group (RAID number “01”) is the combination of FC recognition information “FC-Port0” and disk discrimination information “Disk1” and a combination of FC recognition information “FC-Port1” and disk discrimination information “Disk1”. Further, the disk position d1e to specify the disk position of the FC disk 12d belongs to the first RAID group is the combination of FC recognition information “FC-Port2” and disk discrimination information “Disk1” and a combination of FC recognition information “FC-Port3” and disk discrimination information “Disk1”.

Similarly the disk position d1e to specify the disk position of the SATA disk 13a belongs to the second RAID group (RAID number “02”) is the combination of FC recognition information “FC-Port0” and disk discrimination information “Disk2” and a combination of FC recognition information “FC-Port1” and disk discrimination information “Disk2”. Further, the disk position d1e to specify the disk position of the SATA disk 13b belongs to the second RAID group is the combination of FC recognition information “FC-Port0” and disk discrimination information “Disk3” and a combination of FC recognition information “FC-Port1” and disk discrimination information “Disk3”. The disk position d1e to specify the disk position of the SATA disk 13c belongs to the second RAID group is the combination of FC recognition information “FC-Port0” and disk discrimination information “Disk4” and a combination of FC recognition information “FC-Port1” and disk discrimination information “Disk4”.

The management table d2 manages the number of accesses (an access state) to FC disks 12 for each of the FC paths 15a-15d. Here, if an FC disk 12 arranged on an FC path 15 is not being accessed at all, the management table d2 allocates the number of accesses through the same FC path 15 to “0x0000 0000” (see FIG. 6). Conversely, if an FC disk 12 arranged on an FC path 15 is being accessed, the management table d2 allocates the number of accesses through the same FC path 15 to a value obtained by an increment in “0x0000 0000” representing the number of accesses through the FC path 15.

For example, while the number of accesses through one FC path 15 is indicating “0x0000 0000”, starting of access to an FC disk 12 arranged on the same FC path 15 causes the management table d2 to increase the access number “0x0000 0000” to the value of “0x0000 0001”. Further, another access to the same FC disk 12 are made through the FC path 15, the management table d2 increases the value of “0x0000 0001” to “0x0000 0002”. During this state, termination of the access to the FC disk 12 through the FC path 15 prompts the management table d2 to decrease the access number to the value of “0x0000 0000”.

The monitoring section 18 monitors an access state to the FC disks 12. In the first embodiment, the monitoring section 18 monitors the number of accesses to an FC disk 12 for each of a number of FC paths 15a-15d with reference to the management table d2.

The selecting section 19 selects on the basis of the access state monitored by the monitoring section 18 one from the bridge 14 and the CM firmware 20 that is to be detailed below when storing object data managed in the first LBA unit length L1 is to be stored into the SATA disk 13.

If the FC disk 12 is judged, on the basis of the access state monitored by the monitoring section 18, to be currently accessed, the selecting section 19 selects the bridge 14. Specifically, if the number of accesses monitored by the monitoring section 18 is one or more, that is, if the management table d2 is set to be the value except for “0x0000 0000”, the selecting section 19 judges that the FC disk 12 is being accessed. Conversely, if the selecting section 19 judges on the basis of the access state monitored by the monitoring section 18 that the FC disk 12 is not being accessed, the selecting section 19 selects the CM firmware 20.

The CM firmware 20 performs a second conversion (Reading, Modifying, and Writing), which is different from the first conversion, in order to convert the control unit of storing object managed in the first LBA unit length L1 to the second LBA unit length L2. In other words, the CM firmware 20 converts the control unit 19 of storing object data in the first LBA unit length L1 through the second conversion so that the storing object data managed in the first LBA unit length L1 is stored into the SATA disk 13 in the second LBA unit length L2. The CM firmware 20 then writes (stores) into the SATA disk 13 the storing object data converted into data in the second LBA unit length L2 through the bridge 14 associated with the SATA disk 13 in question. In the first embodiment, the CM firmware 20 makes accesses to disks in the first LBA unit length L1.

Here, the second conversion is performed by reading data in a unit of a common multiple of the first LBA unit length L1 and the second LBA unit length L2 from the CM firmware 20, which retains the storing object data in the first LBA unit length, and the SATA disk 13, into which the storing object data in the second LBA unit L2, and merging the data from the CM firmware 20 and the SATA disk 13.

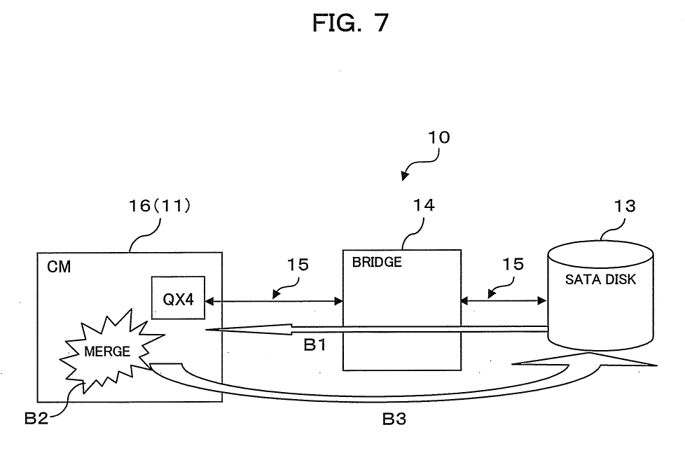

FIG. 7 is a diagram explaining the function of the CM firmware 20 in the RAID apparatus 10 of the first embodiment.

Hereinafter, description will now be made in relation to an example of execution of the second conversion with reference to FIGS. 3(a), 3(b), and 7.

As depicted in FIG. 7, when the first unit data LBA1-1 of the FC logical data depicted in FIG. 3(a) is to be updated, the CM firmware 20 reads the second-unit data blocks LBA2-0 through LBA2-64 from the entire SATA physical data Y (see FIG. 3(b), 65 data blocks in the example of FIG. 3(b)) stored in the corresponding SATA disk 13 (see arrow B1 in FIG. 7).

The CM firmware 20 performs the above conversion on the first unit data LBA1-1 serving as data used for updating. In other words, the CM firmware 20 carries out the above conversion so that an LBA from which writing is started is a multiple of 64 and the number of LBAs that are to be written is a multiple of 64. Then the CM firmware 20 merges in the buffer (not illustrated) the storing object data, into which the firs unit data LBA1-1 has been converted through the second conversion, and the read second unit data LBA2-0 through LBA2-64 (see arrow B2 in FIG. 7). Upon completion of merging, the data obtained through merging is written into a storage object region, in which the SATA physical data were stored, of the SATA disk 13 through the bridge 14 (see arrow B3 in FIG. 7). Namely, in the RAID apparatus 10 of the first embodiment, the CM firmware 20 has a function as a bridge 14. Accordingly, the selecting section 19 selects a method of converting data from the first conversion and the second conversion on the basis of the access state monitored by the monitoring section 18 when the controller 11 is to access to the SATA disk 13.

Here, the CM firmware 20 does not need to serialize storing object data differently from the first conversion that the bridge 14 performs when the second conversion is performed. This is because the CM firmware 20 has a function to issue a multiple I/O requests (Disk I/O; Read/Write) in order to perform an NCQ (Native Command Queuing) on an FC disk 12. Therefore, upon completion of merging, the CM firmware 20 can write the data obtained through merging into a storing object region in the SATA disk 13 for 64 data blocks of the first unit data LBA1-0 through LBA1-63 corresponding to the entire FC logical data X in a lump.

In the first embodiment, in writing data into the FC disk 12 by the CM firmware 20, the CM firmware 20 outputs data in the first LBA unit length L1 kept in the first LBA unit length L1 to the FC disk 12. Further, if the selecting section 19 selects the bridge 14, the CM firmware 20 sends storing object data managed in the first LBA unit length L1 kept in the first LBA unit length L1 to the bridge 14.

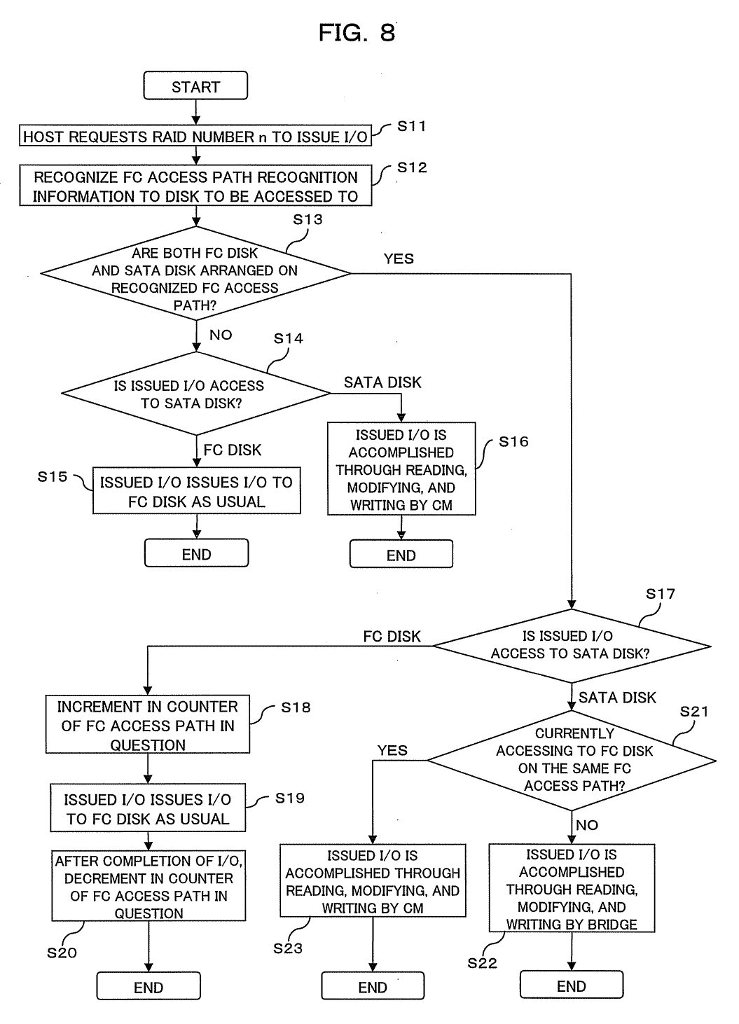

A method for file control performed in the RAID apparatus 10 of the first embodiment having the above configuration is detailed with reference to the flow diagram (steps S11 through S23) depicted in FIG. 8.

In response to issuing of a write request (I/O issuing request) into RAID number n (where n is a natural number) from a higher apparatus (step S11) the CM firmware 20 recognizes FC recognition information of an FC path 15 to which the disk (an FC disk 12 or the SATA disk 13) to be accessed belongs with reference to the disk position d1e in the disk configuration information d1 (step S12).

The CM firmware 20 judges, with reference to disk positions d1e in the disk configuration information d1, whether or not both an FC disk 12 and an SATA disk 13 are arranged on the FC path 15 associated with the recognized FC path recognition information (step S13).

If the result of the judgment in step S13 is negative (No route in step S13), the CM firmware 20 further judges, with reference to the disk configuration information d1, whether the issued writing request is directed to an FC disk 12 or an SATA disk 13 (step S14). This judgment is made with reference to the disk type d1c associated with the disk position d1e of the disk to be accessed in the disk configuration information d1.

If the issued writing request is directed to an FC disk 12 (“FC disk” route in step S14), the CM firmware 20 issues a writing request to the FC disk 12 as usual (step S15) and terminates the procedure.

Conversely, if the issued writing request is directed to an SATA disk 13 (“SATA disk” route in step S14), the CM firmware 20 carries out the second conversion and terminates the procedure.

If the result of the judgment in step S13 is positive (Yes route in step S13), the CM firmware 20 further judges, with reference to the disk configuration information d1, whether the issued writing request is directed to an FC disk 12 or an SATA disk 13 (step S17). This judgment is made with reference to the disk type d1c associated with the disk position d1e of the disc to be accessed in the disk configuration information d1.

If the issued writing request is directed to an FC disk 12 (“FC disk” route in step S17), the CM firmware 20 increases the number of accesses to the FC path 15 on which the disk to be accessed is arranged (hereinafter the path is called an FC path to be accessed) in the management table d2 (step S18). The CM firmware 20 then issues a writing request to the FC disk 12 as usual (step S19). Upon completion of the process responsive to the issued writing request, the CM firmware 20 decreases the number of accesses through the FC path 15 to be accessed (step S20) and terminates the procedure.

If the issued writing request is directed to an SATA disk 13 (“SATA disk” route in step S17), the selecting section 19 judges whether or not an FC disk 12 arranged on the same FC path 15 as the SATA disk 13 is currently being accessed, in other words, whether or not the number of accesses to the FC path to be accesses is zero (step S21).

If the FC disk 12 arranged on the same FC path 15 is not being accessed (NO route in step S21), the CM firmware 20 performs the second conversion (step S22) and terminates the procedure.

Conversely if the FC disk 12 arranged on the same FC path 15 is being accessed (YES route in step S21), the CM firmware 20 forwards the storing object data without being converted to the bridge 14, which performs the first conversion on the received data (step S23) and terminates the procedure.

As described above, the RAID apparatus 10 of the first embodiment causes the CM firmware 20 to carry out the second conversion on storing object data if a writing request from a higher apparatus is directed to an SATA disk 13 arranged on an FC path 15 to which an FC disk 12 currently not being accessed belongs and on which both the FC disk 12 and the SATA disk 13 are arranged. On the other hand, if the FC disk 12 on the same FC path 15 is currently being accessed, the bridge 14 carries out the first conversion on the storing object data.

The bridge 14 performs the above conversion on storing object data after serializing the received storing object data. For this reason, the first conversion performed in the bridge 14 impairs accessibility as compared with the second conversion performed by the CM firmware 20 (e.g., decreases the processing speed).

The CM firmware 20 does not need to serialize storing object data before performing the second conversion on the object data differently from the first conversion performed by the bridge 14. Therefore, the CM firmware 20 performs the second conversion so that the LBA from which writing is started is a multiple of the number 64 and the number LBAs into data is to be written is a multiple of the number 64. This can avoid the requirement for the first conversion performed in the bridge 14 and consequently enhance the accessibility as compared to the first conversion performed in the bridge 14 (e.g., increases the processing speed).

However, after the CM firmware 20 performs the second conversion on storing object data, the data to be forwarded to the SATA disk 13 passes through an FC path 15 also serving as the access path to the FC disk 12. If the CM firmware 20 is making accesses to both the 12 and the SATA disk 13 at the same time, performance problems may arise. For example, when the CM firmware 20 accesses to an SATA disk 13 while accessing to the FC disk 12 arranged in the same FC loop P as the SATA disk 13, performing of the second conversion in the CM firmware 20 results in redundant data transferring through the FC path 15. This may impair the accessibility to the FC disk 12. Since excessive data (e.g., the first unit data LBA1-0, 1-2, and 1-63 except the first unit data LBA1-1) flows through an access path to the FC disk 12, there is disadvantage in performance if the FC paths serve as a bottleneck.

One solution to avoid the above problems may perform conversion on storing object data fixedly in the bridge 14 when an SATA disk 13 is to be accessed in an FC loop P including the SATA disk 13 and an FC disk 12. However, conversion fixedly performed in the bridge 14 may lower the accessibility to the SATA disk 13 while the FC disk 12 is not being accessed.

Conversely, the RAID apparatus 10 of the first embodiment can have a higher processing speed than a case where conversion is carried out in the bridge 14 when the FC disk 12 is not accessed. In addition, the RAID apparatus 10 can maintain accessibility of a certain level since, differently from a case where the second conversion is performed by the CM firmware 20, excessive data does not flow through the FC path 15 wile the FC disk 12 is being accessed.

As a result, it is possible to improve accessibility to disks 12 and 13 having respective different LBA unit lengths L1 and L2 on an RAID apparatus 10 including these disks 12 and 13.

(b) Others:

The disclosed technique should by no means be limited to the foregoing embodiment, and various changes and modifications can be suggested without departing from the gist of the embodiment.

For example, the first embodiment assumes that an FC loop P includes both the FC disk 12 and the SATA disk 13. However, the first embodiment is not limited to this. Alternatively, the first embodiment may be applied to an FC loop P including a number of disks managed in different LBA unit lengths.

Further, the CM 16 of the first embodiment includes the monitoring section 18, the selecting section 19, and the CM firmware 20 in the separated forms. However, the CM 16 is not limited to this. Alternatively, the CM firmware 20 may function also as the monitoring section 18 and the selecting section 19.

Further, in the first embodiment, the selecting section 19 judges that the FC disk 12 is being accessed if the number of accesses monitored by the monitoring section 18 is not zero. However, the judgment is not limited to this. Alternatively, the FC disk 12 may be judged to be currently accessed when the number of accesses monitored by the monitoring section 18 is a predetermined number or more. Such a predetermined number can be set by the user as required. Accordingly, the selecting section 19 selects the first conversion when the number of accesses monitored by the monitoring section 18 is the predetermined number or more.

In the first embodiment, the number of accesses is managed for each individual FC path 15 is managed, but the access number management is not limited to this. Alternatively, the number of accesses to one or more arranged on each of the FC loops P1 and P2 may be managed. In this case, the CM firmware 20 may increase or decreases the number of accesses through each of FC paths (e.g., 15a and 15b) that form the same FC loop p (e.g., the FC loop P1) at the same time.

The CPU (not illustrated) incorporated in the CM 16 executes a control program of the RAID apparatus 10 so that the functions of the monitoring section 18, the selecting section 19, and the CM firmware 20 are realized.

The control program to realize the functions of the monitoring section 18, the selecting section 19, and the CM firmware 20 is provided in the form of being recorded in a computer-readable recording medium, such as a flexible disk, a CD (e.g., CD-ROM, CD-R, CD-RW), a DVD (e.g., DVD-ROM, DVD-RAM, DVD-R, DVD+R, DVD-RW, DVD+RW, HD-DVD, Blu-ray™ Disk), a magnetic disk, an optical disk, or a magneto-optical disk. Further, the computer may read the control program from the recording medium and sends the read program to an internal or external memory to store for use. Further alternatively, the read program may be recorded in a memory device (a recording medium), such as a magnetic disk, an optical disk, a magneto-optical disk or a semiconductor storage, and is provided to the computer from the memory device through a communication path.

In order to realize the functions as the monitoring section 18, the selecting section 19, and the CM firmware 20, a microprocessor in the computer executes the program stored in an internal memory. At that time, the execution may be carried out by computer reading the program stored in a recording medium.

Here, a computer is a concept of a combination of hardware and an OS and means hardware which operates under control of the OS. Otherwise, if an application program operates hardware independently of an OS, the hardware corresponds to the computer. Hardware includes at least a microprocessor such as a CPU and means to read a computer program recorded in a recording medium. In the first embodiment, the controller 11 serves to function as a computer.

The recording medium used in the first embodiment may be various computer-readable recording media such as an IC card, a ROM cartridge, a magnetic tape, a punch card, an internal storage unit (RAM or ROM or the like) for a computer, an external storage unit, or a printing matter on which codes, such as bar codes, are printed, in addition to a flexible disk, a CD, a DVD, a magnetic disk, an optical disk, a magnet-optical disk and a semiconductor storage above listed.

The technique disclosed herein can improve the accessibility to disks having different LBA unit lengths, respectively, on an RAID apparatus including these disks.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A disk array apparatus comprising:
a first storage unit storing data in a first control unit;
a second storage unit storing data in a second control unit different from the first control unit;
a controller managing data in the first control unit and controlling data storing into said first storage unit and said second storage unit; and
a first converting unit, arranged on a first access path between said controller and said second storage unit, if receiving object data to be stored into said second storage unit which object data is in the first control unit, performing a first conversion on the object data to convert the object data into data in the second control unit,
said controller comprising
a monitoring section monitoring a state of access to said first storage unit,
a selecting section selecting, on the basis of the state monitored by said monitoring section, one from said controller and said first converting unit when the object data managed in the first control unit is to be stored into said second storage unit, and
a second converting unit performing, if said controller is selected by said selecting section, a second conversion, different from the first conversion, on the object data to convert the object data managed in the first control unit into data in the second control unit.

2. A disk array apparatus according to claim 1, wherein, if said first converting unit receives from said controller the object data in the second control unit, said first converting unit passes the object data kept in the second control unit.

3. A disk array apparatus according to claim 1, wherein, if said first converting section is selected by said selecting section, said second converting section sends the object data managed in the first control unit kept in the first control unit to said first converting section.

4. A disk array apparatus according to claim 1, wherein said first converting section is arranged on a position branched from a second access path between said controller and said first storage unit.

5. A disk array apparatus according to claim 1, wherein, if said first storage unit is judged on the basis of the state monitored by said monitoring section to be currently accessed, said selecting section selects said first converting unit.

6. A disk array apparatus according to claim 5, wherein:
said monitoring section monitors the number of accesses to said first storage unit; and
said selecting section judges, if the number of accesses monitored by said monitoring section is a predetermined value or more, that said first storage unit is being accessed.

7. A disk array apparatus according to claim 1, wherein:
the first conversion is performed by reading only data which is managed in the second control unit from a region of said second storage unit into which region the object data is to be stored and converting the object data and the read data; and
the second conversion is performed by reading data which is managed in the second control unit in a unit of a common multiple of a data length of the first control unit and a data length of the second control unit from said second storage unit and converting the object data and the read data.

8. A controller for a disk array apparatus comprising a first storage unit storing data in a first control unit, a second storage unit storing data in a second control unit different from the first control unit, a first converting unit, arranged on a first access path between said controller and the second storage unit, if receiving object data to be stored into said second storage unit which object data is in the first control unit, performing a first conversion on the object data to convert the object data into data in the second control unit, said controller that manages data in the first control unit and controls data storing into the first storage unit and the second storage unit comprising:
a monitoring section monitoring a state of access to the first storage unit;
a selecting section selecting, on the basis of the state monitored by said monitoring section, one from said controller and the first converting unit when the object data managed in the first control unit is to be stored into the second storage unit; and
a second converting unit performing, if said controller is selected by said selecting section, a second conversion, different from the first conversion, on the object data to convert the object data managed in the first control unit into data in the second control unit.

9. A controller according to claim 8, wherein, if said first converting section is selected by said selecting section, said second converting section sends the object data managed in the first control unit kept in the first control unit to the first converting section.

10. A controller according to claim 8, wherein, if the first storage unit is judged, on the basis of the state monitored by said monitoring section, to be currently accessed, said selecting section selects the first converting unit.

11. A controller according to claim 10, wherein:
said monitoring section monitors the number of accesses to said first storage unit; and
said selecting section judges, if the number of accesses monitored by said monitoring section is a predetermined value or more, that said first storage unit is being accessed.

12. A controller according to claim 8, wherein:
the first conversion is performed by reading only data which is managed in the second control unit from a region of the second storage unit into which region the object data is to be stored and converting the object data and the read data; and
the second conversion is performed by reading data which is managed in the second control unit in a unit of a common multiple of a data length of the first control unit and a data length of the second control unit from the second storage unit and converting the object data and the read data.

13. A method for controlling a disk array apparatus comprising a first storage unit storing data in a first control unit, a second storage unit storing data in a second control unit different from the first control unit, a controller managing data in the first control unit and controlling data storing into the first storage unit and the second storage unit, and a first converting unit, arranged on a first access path between the controller and the second storage unit, if receiving object data to be stored into the second storage unit which object data is in the first control unit, performing a first conversion on the object data to convert the object data into data in the second control unit, said method comprising:
monitoring of a state of access to the first storage unit;
when the object data managed in the first control unit is to be stored into said second storage unit, selecting, on the basis of the state monitored in said step of monitoring, one from the controller and the first converting unit; and
performing, if the controller is selected in said step of selecting, a second conversion, different from the first conversion, on the object data to convert the object data managed in the first control unit into data in the second control unit.

14. A method according to claim 13, wherein, if the first converting section is selected in said step of selecting, the object data managed in the first control unit kept in the first control unit is sent to the first converting unit in said step of performing the second conversion.

15. A method according to claim 13, wherein, if the first storage unit is judged in said step of monitoring to be currently accessed, the first converting section is selected in said step of selecting.

16. A method according to claim 15, wherein:
the number of accesses to the first storage unit is monitored in said step of monitoring; and
if the number of accesses monitored in said step of monitoring is a predetermined value or more, the first storage unit is judged to be currently accessed in said step of selecting.

17. A method according to claim 13, wherein:
the first conversion is performed by reading only data which is managed in the second control unit from a region of the second storage unit into which region the object data is to be stored and converting the object data and the read data; and
the second conversion is performed by reading data which is managed in the second control unit in a unit of a common multiple of a data length of the first control unit and a data length of the second control unit from the second storage unit and converting the object data and the read data.

18. A computer readable recording medium in which a program for a controlling a disk array apparatus comprising a first storage unit storing data in a first control unit, a second storage unit storing data in a second control unit different from the first control unit, a controller managing data in the first control unit and controlling data storing into the first storage unit and the second storage unit, and a first converting unit, arranged on a first access path between the controller and the second storage unit, if receiving object data to be stored into the second storage unit which object data is in the first control unit, performing a first conversion on the object data to convert the object data into data in the second control unit, wherein said program instructs a computer to function as:
a monitoring section monitoring a state of access to said first storage unit, a selecting section selecting, on the basis of the state monitored by said monitoring section, one from said controller and said first converting unit when the object data managed in the first control unit is to be stored into said second storage unit, and
a second converting unit performing, if said controller is selected by said selecting section, a second conversion, different from the first conversion, on the object data to convert the object data managed in the first control unit into data in the second control unit.
